(19) United States
(12) Patent Application Publication
(10) Pub. No.: US 2007/0042795 A1
(43) Pub. Date: Feb. 22, 2007

(54) Method of band multiplexing to improve system capacity for a multi-band communication system

(76) Inventors: Shaomin Samuel Mo, Monmouth Junction, NJ (US); Alexander D. Gelman, Smallwood, NY (US)

Correspondence Address: RATNERPRESTIA, P.O. BOX 980, VALLEY FORGE, PA, 19482, US

(21) Appl. No.: 11/395,086

(22) Filed: Mar. 31, 2006

Related U.S. Application Data
(63) Continuation-in-part of application No. 11/207,520, filed on Aug. 19, 2005.

(51) Int. Cl. H04B 7/00; H04B 15/00

(52) U.S. Cl. 455/502

(57) ABSTRACT

A control method of synchronizing communications between or among a plurality of devices in a communication system includes detecting beacons from the plurality of devices in the communication system, establishing a reservation for at least a portion of the plurality of devices in the communication system, each reservation being a frame interval in which to transmit symbols from one device to one or more other devices in the communications system, determining, by each device, a time-frequency code for each of the other devices in the communication system according to the detected beacons from the other devices, adjusting a frequency band for transmission by a respective device according to the determined time-frequency code, and transmitting a plurality of symbols from the respective device using the adjusted frequency band.

### CROSS REFERENCE TO RELATED APPLICATION

This U.S. patent application is a Continuation-In-Part of U.S. patent application Ser. No. 11/207,520, filed on Aug. 19, 2005 having Attorney Docket No. MATI-254US, and claims the benefit thereof. The contents of U.S. patent application Ser. No. 11/207,520 are herein incorporated by reference.

### FIELD OF THE INVENTION

The present invention relates to the field of wireless communications and, more particularly, to a method of band multiplexing to improve system capacity for a multi-band communication system.

### BACKGROUND OF THE INVENTION

Ultra Wideband (UWB) technology uses base-band pulses of very short duration to spread the energy of transmitted signals very thinly from near zero to several GHz. This technology is presently in use in military applications. Commercial applications will soon become possible due to a recent Federal Communications Commission (FCC) decision that permits the marketing and operation of consumer products incorporating UWB technology.

Presently, UWB is under consideration by the Institute of Electrical and Electronic Engineers (IEEE) as an alternative physical layer technology. See IEEE Standard 802.15.3a, which is designed for home wireless audio/video systems. Under this standard UWB systems are assumed to operate in an environment of uncoordinated piconets. Piconets, sometimes referred to as personal area networks (PANs), are formed when at least two devices, such as a portable PC and a cellular phone, connect.

Packet error rates (PER) can be attributed to narrow band interference (NBI) and to collision of packets (i.e., symbols or information bits) transmitted on common communication (e.g., frequency) bands. “Multi-band” modulation technologies have been developed for UWB communication systems to deal with NBI. In multi-band UWB communication systems, the UWB frequency band is divided into multiple sub-bands utilizing a different spreading waveform in each of the sub-bands. One of the advantages of a multi-band UWB system is its ability to work in environments having NBI. When NBI is detected, multi-band UWB systems may automatically shut down the corresponding sub-bands shared with the NBI to reduce the effect of the NBI. Time/frequency hopping may be utilized in multi-band UWB systems to further reduce NBI effects.

FIG. 1 is a conceptual representation of a multi-band spectrum allocation for a UWB communication system which is in accordance with FCC mandates for such systems. The UWB spectrum of 7.5 GHz in the 3.1 GHz to 10.6 GHz frequency band is divided into 14 bands and each of bands 1-14 occupies 528 MHz of bandwidth. Bands 1-14 are grouped into band groups 1-5. For devices using UWB communication support for band group 1 is mandatory while it is optional for band groups 2-5.

FIG. 2A is a schematic diagram of a conventional superframe used for communication among a plurality of UWB devices in the UWB communication system.

FIG. 2B is an exemplary grouping of the UWB devices. Although 3 UWB devices are shown, any number of devices may be included in the UWB communication system.

Referring now to FIGS. 2A and 2B, because there is no central controller for piconet management, UWB devices A, B, and C from different but overlapping piconets coordinate themselves. Beaconing technology may be used for piconet management. Each UWB device A, B and C may transmit a respective beacon during a respective beacon slot S1-S3 and may listen to other UWB devices A, B and C for their beacons. Beacons from UWB devices A, B and C in a common area 20 may form a beacon group. When, for example, UWB device B joins an existing beacon group of UWB devices A and C, its beacon is placed at the end of the beacon group in beacon slot S3. When, for example, UWB device A leaves the beacon group, other UWB devices B and C move their beacons forward to beacon slots S1 and S2, respectively, to make the beacon group as short as possible. Short beacon groups allow for more time in a superframe 200, 201 and 202 to allocate for data exchange.

The basic timing structure for data exchange is superframe (e.g., 200, 201 and 202). Each superframe 200, 201 and 202 comprises (1) a beacon period (BP) 210, which is used to set timing allocations and to communicate management information for the piconet; (2) a priority channel access (PCA) period 220, which is a contention-based channel access that is used to communicate commands and/or asynchronous data; and (3) a distributed reservation protocol (DRP) period 230, which enables UWB devices A, B and C to reserve reservation blocks 240-1, 240-2 . . . 240-N outside of BP 210 of superframes 200, 201 and 202. DRP period 230 may be used for commands, isochronous streams and asynchronous data connections. Reservations made by UWB device A, B and C specify one or more reservation blocks 240-1, 240-2 . . . 240-N that UWB device A, B and C may use to communicate with one or more other UWB devices A, B and C on the piconet. UWB devices A, B and C using DRP period 230 for transmission or reception may announce reservations by including DRP Information Elements (IEs) in their beacons.

Each UWB device A, B and C may reserve an integral number of reservation blocks 240-1, 240-2 . . . 240-N (e.g., reservations may be made in units of reservation blocks). UWB devices A, B and C may reserve multiple reservation blocks which may not be consecutive. That is, these multiple reservation blocks may have portions which are consecutive and other portions which are not consecutive. UWB devices A, B and C may reserve excess reservation blocks for error correction relevant retransmission and other control data, among others. Each UWB device A, B and C may start transmission at the beginning of a respective reserved reservation block.

Each reservation block 240-1, 240 . . . 240-N may include a plurality of frames 260 and may include intra-frame periods 270 and 280 such as MIFS periods, SIFS periods and a Guard period, among others. Conventionally, these intra-frame periods 270 and 280 are fixed duration periods, for example, typically, the MIFS period is 1.875 μs, the SIFS period is 10 μs, and the Guard period is 12 μs. These periods in a conventional UWB system are not integer multiples of a symbol period.

UWB devices A, B and C may simultaneously transmit symbols (i.e., information bits) during frames 260 using Orthogonal Frequency Division Multiplexing (OFDM) modulation. Symbols may be interleaved across various bands to exploit frequency diversity and provide robustness against multi-path interference.

A simultaneously operating piconet (SOP) refers to, for example, multiple UWB devices A, B and C which may operate in different piconets in a common coverage area 20. When these devices A, B and C are used in apartment buildings, for example, the probability is high that multiple SOPs are operating. One challenge for communication systems is dealing with interference caused by multiple SOPs that operate nearby. One method for minimizing interference among SOPs is to assign each SOP a different TFC (i.e., channel).

FIG. 3 is a chart illustrating a conventional time-frequency code for band groups 1-4 illustrated in FIG. 1. For each band group 1-4, channels 1-7 may be established such that UWB device A may communicate over channel 1, UWB device B may communicate over channel 2 and UWB device C may communicate over channel 3. That is, for example, (1) in a first symbol period T1, UWB devices A, B, and C may communicate over frequency band 1; (2) in a second symbol period T2, UWB device A may communicate over frequency band 2, UWB device B may communicate over frequency band 3, and UWB device C may communicate over frequency band 1; (3) in a third symbol period T3, UWB device A may communicate over frequency band 3, and UWB devices B and C may communicate over frequency band 2. Each channel may have a unique time/frequency hopping scheme, also referred to as a time-frequency code (TFC).

To support multiple SOPs and avoid interference, the information bits (i.e., symbols) are spread using the TFC. Typically, there are two types of TFCs used: ones in which symbols are interleaved over multiple bands, referred to as Time-Frequency Interleaving (TFI); and ones in which symbols are transmitted on a single band, referred to as Fixed Frequency Interleaving (FFI). Typically, each of the band groups 1-4 support both TFI and FFI.

For example, UWB devices assigned the conventional TFC shown in FIG. 3 may communicate over channels 1-4 using TFI, while UWB devices assigned other conventional TFC shown in FIG. 3 may communicate over channels 5-7 using FFI and may completely avoid collision. However, because all symbols from a UWB device using, for example, channel 5 are transmitted on frequency band 1, total transmission power for frequency band 1 from the one UWB device is 4.7 dB higher than if distributed over frequency bands 1-3. Correspondingly, the FCC mandates that transmitters on channels 5-7, be required to reduce transmission power by 4.7 dB which results in a reduced coverage range.

### SUMMARY OF THE INVENTION

The present invention is embodied as a control method to synchronize communications between or among a plurality of devices in a communication system. The control method includes detecting beacons from the plurality of devices in the communication system, establishing a reservation for at least a portion of the plurality of devices in the communication system, each reservation being a frame interval in which to transmit symbols from one device to one or more other devices in the communications system, determining, by each device, a time-frequency code for each of the other devices in the communication system according to the detected beacons from the other devices, adjusting a frequency band for transmission by a respective device according to the determined time-frequency code, and transmitting a plurality of symbols, as a symbol system, from the respective device using the adjusted frequency band.

The present invention may also be embodied as a method of band multiplexing communications from the plurality of devices in the communication system. The method includes establishing a rotation, by each device, between or among a plurality of frequency bands for transmission, transmitting a symbol set from each device at each of the established transmission frequencies such that simultaneous transmissions by respective devices are at different transmission frequencies, determining whether a start of each respective symbol set for a respective device is corrupted and when the start of the symbol set is determined to be corrupted, adjusting a clock timing of the respective device to reduce or substantially eliminate symbol corruption in subsequently transmitted symbol sets of the respective device.

The present invention may be further embodied as a computer readable carrier including software that is configured to control a general purpose computer to implement a method embodied in a computer readable medium to control communication from a device in the communication system. The method includes detecting beacons from the plurality of devices in the communication system, establishing a reservation for at least a portion of the plurality of devices in the communication system, each reservation being a frame interval in which to transmit symbols from one device to one or more other devices in the communications system, determining, by each device, a time-frequency code for each of the other devices in the communication system according to the detected beacons from the other devices, adjusting a frequency band for transmission by a respective device according to the determined time-frequency code, and transmitting a plurality of symbols from the respective device using the adjusted frequency band.

### BRIEF DESCRIPTION OF THE DRAWINGS

The invention is best understood from the following detailed description when read in connection with the accompanying drawings. It is emphasized that, according to common practice, various features/elements of the drawings may not be drawn to scale. On the contrary, the dimensions of the various features/elements may be arbitrarily expanded or reduced for clarity. Moreover in the drawings, common numerical references are used to represent like features/elements. Included in the drawing are the following figures:

FIG. 1 (Prior Art) is a conceptual representation of a multi-band spectrum allocation for a UWB communication system;

FIG. 2A (Prior Art) is a schematic diagram of a conventional superframe used for communications among a plurality of devices in the UWB communication system;

FIG. 2B (Prior Art) is an illustration of an exemplary grouping of UWB devices;

FIG. 3 (Prior Art) is a chart illustrating a conventional time-frequency code for band groups 1-4 of FIG. 1;

FIG. 4A is a chart illustrating exemplary time-frequency codes in accordance with an exemplary embodiment of the present invention;

FIG. 4B is a schematic diagram illustrating a distributed reservation protocol (DPR) used in various embodiments of the present invention;

FIG. 5 is a flow chart of a control method for synchronization of a communication system in accordance with another exemplary embodiment of the present invention;

FIG. 6 is a flow chart illustrating an adjustment method for adjusting clock timing of a respective UWB device;

FIG. 7 is a timing diagram of exemplary communications from a plurality of UWB devices in a communication system in accordance with yet another exemplary embodiment of the present invention;

FIGS. 8 and 9 are timing diagrams illustrating collisions between devices in a multi-band communication system when the devices have slightly unsynchronized clocks;

FIG. 10 is a timing diagram illustrating timing of symbols for two devices in a multi-band communication system in accordance with yet another exemplary embodiment of the present invention when the devices have synchronized clocks;

FIG. 11 is a timing diagram illustrating timing of symbols for two devices in a multi-band communication system for the devices illustrated in FIG. 9 when the devices have slightly unsynchronized clock timing;

FIGS. 12A-12C are timing diagrams illustrating collision patterns of symbols for two devices on a single frequency band when the devices have slightly unsynchronized clock timing;

FIGS. 13 and 14 are timing diagrams illustrating inter-frame periods in accordance with further exemplary embodiments of the present invention; and

FIGS. 15 and 16 are a timing diagrams illustrating timing adjustments in accordance with still further exemplary embodiments of the present invention.

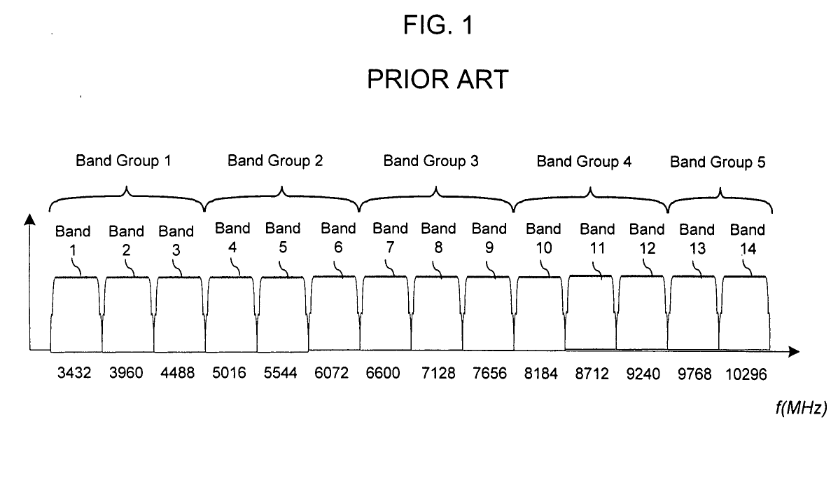

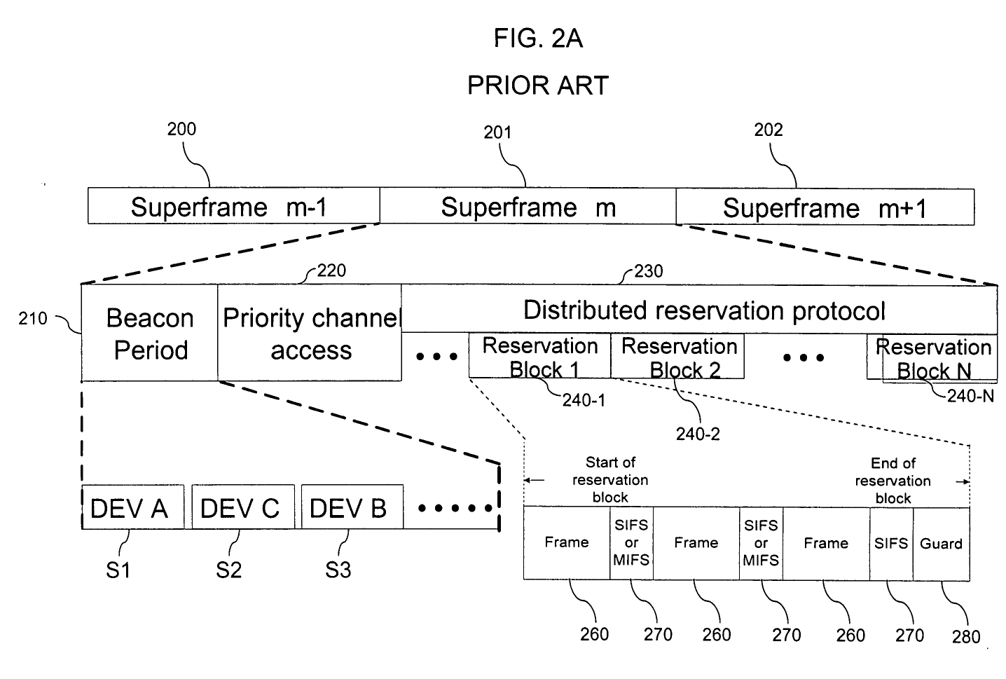

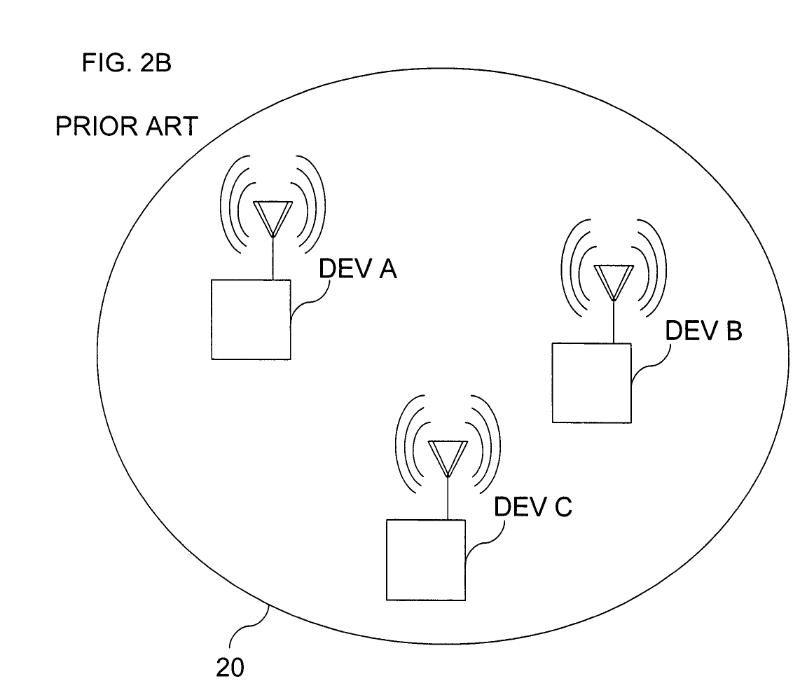

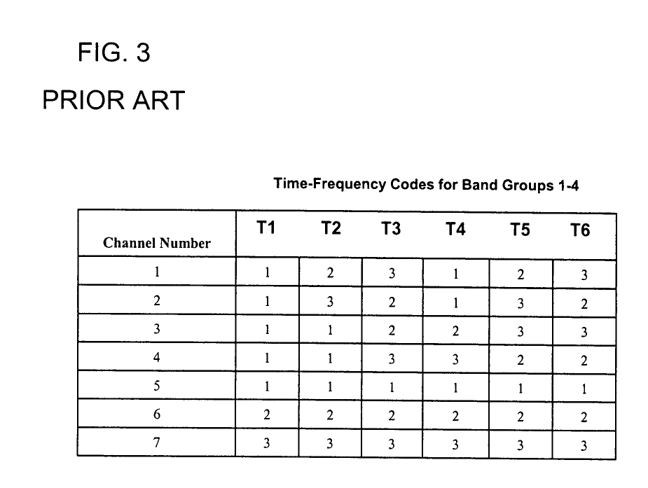

### DETAILED DESCRIPTION OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

UWB communication systems, which may include UWB devices A, B and C are generally known in the art, for example, as illustrated and disclosed in U.S. application Ser. No. 10/751,366 invented by the Inventor of this application, and entitled “METHOD AND APPARATUS FOR RECOVERING DATA IN A RECEIVED CONVOLUTION-ENCODED DATA STREAM” and in an industry association standard entitled “Stand ECMA-368, High Rate Ultra Wideband PHY and MAC Standard, published December 2005.”

Although the present invention is described in terms of UWB communication systems, it may be applied to other communication systems such as non-UWB frequency-hopping and time-hopping communication systems. For example, it is contemplated that embodiments of the present invention may be applicable generally to multi-band communication systems. In such a system, by time-multiplexing symbols of each device in a multi-band communication system, transmission capacity over the multi-band communication system may be improved. Moreover, by transmitting a plurality of time-multiplexed symbols successively (i.e., consecutively) for each device transmitting in a given frequency band, symbol corruption may be reduced and/or substantially eliminated (i.e., as the number of time-multiplexed symbols is increased). Further, by determining corruption of particular symbols in the plurality of time-multiplexed symbols, clock timing of devices may be adjusted to limit clock timing differences between and among devices to improve synchronization.

Clock timing adjustments generally refer to clock synchronization adjustments caused by mismatch of clock rate (skew).

It should be understood that the method illustrated may be implemented in hardware, software, or a combination thereof. In such embodiments, the various components and steps described below may be implemented in hardware and/or software.

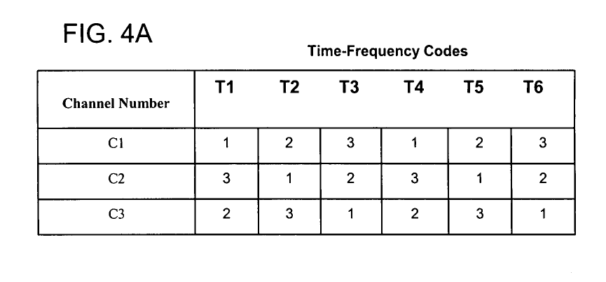

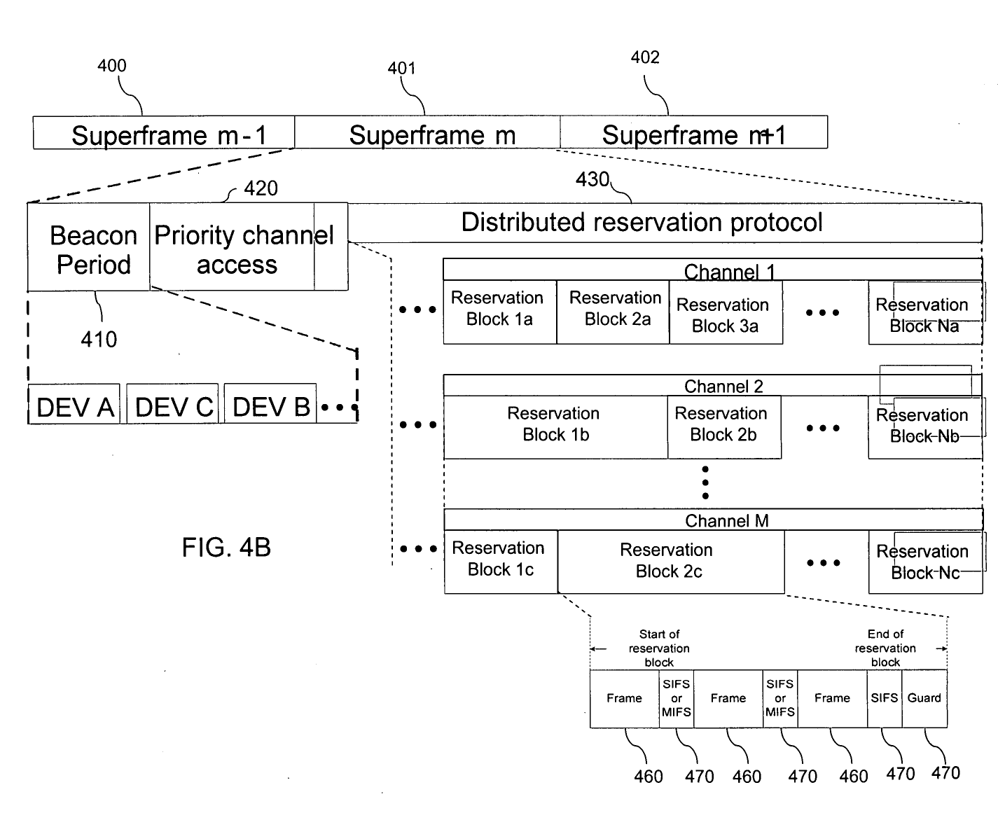

It should also be understood that different UWB devices may operate on different channels in a single SOP or different UWB devices may operate on one or more channels corresponding to a plurality of SOPs as long as different SOPs operate on different channels. That is, any particular UWB device may operate on any SOP or any channel, however, each SOP operates on a separate channel. An example of such an arrangement is illustrated below with respect to FIGS. 4A and 4B.

FIG. 4A is a chart illustrating exemplary time-frequency codes (TFC) in accordance with an exemplary embodiment of the present invention and represents one exemplary band group of a plurality of band groups.

FIG. 4A depicts an exemplary time-frequency hopping scheme (e.g., TFC). For each band group, the TFC may be established to prevent collisions between or among transmissions from two or more UWB devices A, B and C. For example, channels C1, C2 and C3 may be established such that UWB device A, B and C may simultaneously communicate over different channels while, in a synchronized manner, repeatedly frequency hopping to other frequency bands 1-3. That is, for example as shown in FIG. 4: (1) in a first symbol period T1, UWB device A may communicate over frequency band 1, UWB device B may communicate over frequency band 3 and UWB device C may communicate over frequency band 2; (2) in a second symbol period T2, UWB device A may communicate over frequency band 2, UWB device B may communicate over frequency band 1 and UWB device C may communicate over frequency band 3; and (3) in a third symbol period T3, UWB device A may communicate over frequency band 3, UWB device B may communicate over frequency band 2, and UWB device C may communicate over frequency band 1. The communications from UWB devices may be in one or more SOPs according to channel assignments.

It is understood that such a TFC represents a rotation of the frequencies bands for transmission of symbols. That is, one set of symbols (i.e., a plurality of symbols) may be transmitted for each respective UWB device A, B and C on a corresponding frequency band, the transmission frequency of each device may be adjusted to a next corresponding frequency band and another respective set of symbols for each respective device may be further transmitted on the next corresponding frequency band. This process may be repeated until communication from each device is completed. Moreover, the repeated adjustment of the transmission frequency of each device to each next corresponding frequency band may be coordinated between or among the plurality of UWB devices A, B and C based on which TFCs are predefined. The coordination of transmission of the plurality of UWB devices A, B and C may include the establishment of a logical succession of the plurality of frequency bands for transmission such that adjustment of the transmission frequency band of each device occurs by following the established logical succession.

As illustrated in FIG. 4A, the number of SOP's is equal to the number of frequency bands. It is contemplated, however, that any number of SOP's may be simultaneously active, but desirably less than the number of frequency bands in the band group to reduce or substantially eliminate collisions between transmissions from the UWB device in these SOP's.

The logical succession may be a predefined frequency band hopping pattern for which the transmission frequency band of each device does not repeat until all or a portion of the plurality of frequency bands have been transmitted over (i.e., used) for each device or, otherwise may be a logical succession from the transmission frequency band of each device to either (1) the next higher frequency band, where the lowest frequency band is defined as logically the next higher frequency band for the highest frequency band or (2) the next lower frequency, where the highest frequency band is defined as logically the next lower frequency band for the lowest frequency band. It is understood that certain frequency bands may be rendered inactive due to NBI and the TFC may be dynamically changed to accommodate such interference.

FIG. 4B is a schematic diagram illustrating a distributed reservation protocol (DPR) used in various embodiments of the present invention.

Now referring to FIG. 4B, DRP 430 may include simultaneous reservation blocks for respective channels 1-M, for example, of the TFC shown in FIG. 4A. Each UWB device A, B and C may reserve a reservation block 1a, 2a . . . Na; 1b, 2b . . . Nb; or 1c, 2c . . . Nc of a respective channel 1-M. UWB devices A, B and C on different channels may be in the same or different SOPs, as an example, UWB device A may be in a first SOP related to channel 1 of the TFC of FIG. 4A, UWB device B may be in a second SOP related to channel 2 of the TFC of FIG. 4A, UWB device C may be in a third SOP related to channel 3 of the TFC of FIG. 4A. In such a case, UWB device A may reserve, in the beacon period, one or more reservation blocks 1a, 2a . . . Na of channel 1, UWB device B may reserve, in the beacon period, one or more reservation blocks 1b, 2b . . . Nb of channel 2 and UWB device C may reserve, in the beacon period, one or more reservation blocks 1c, 2c . . . Nc of channel M. These respective reservation blocks may be simultaneous (i.e. having portions occurring at the same time), and/or may having different starting and ending points (i.e., may be offset in time). Na, Nb and Nc may be equal or unequal. In the exemplary embodiment shown in FIG. 4B, Na, Nb and Nc are all equal. The total length of all channels are the same, equal to the length of a superframe.

Collision may be reduced or substantially reduced by the synchronization of channels 1-3, for example, as shown in the TFC of FIG. 4A. That is, since channels C1-C3 have synchronized rotation of their transmission frequencies, collisions may be reduced or substantially eliminated. Reservation made in the beacon period by UWB devices A, B and C may request any length reservation block so long as the reservation block is an integer number of preset periods (e.g., for example, the preset period may be one Media Access Slot (MAS) period).

By providing reservations based on symbol level multiplexing (i.e., multiplexing in both the time-domain and frequency domain) by simultaneous reservations on different channels, capacity of the communication system may be increased.

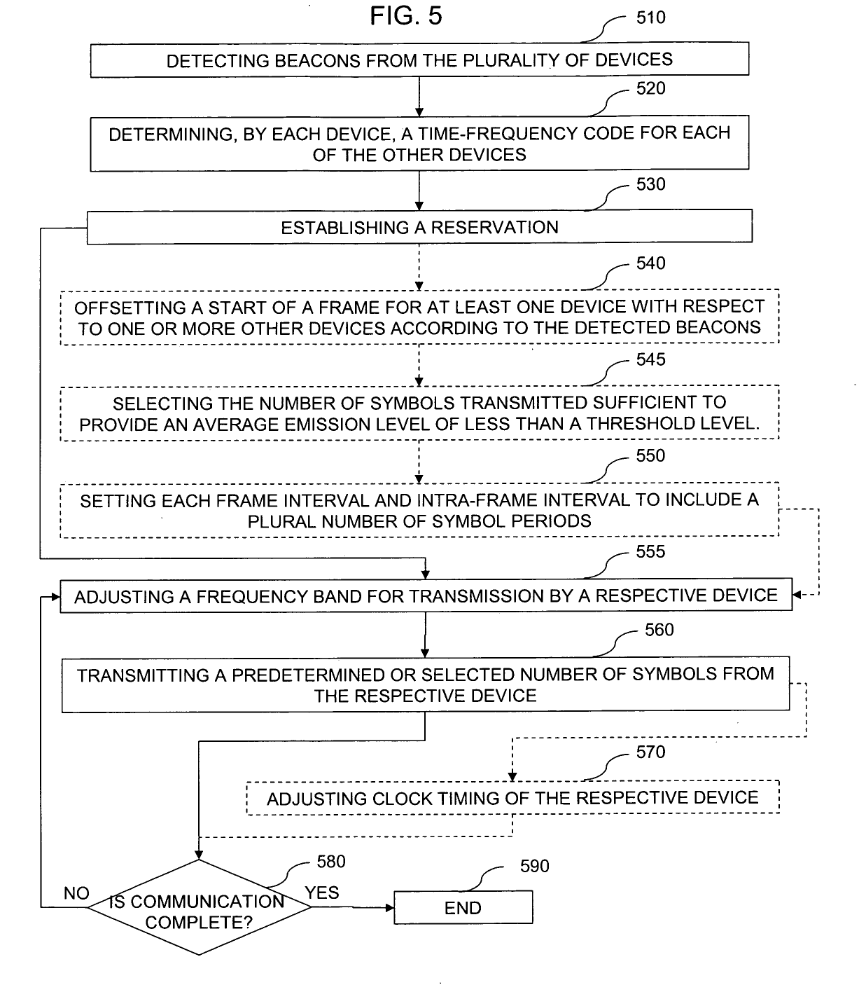

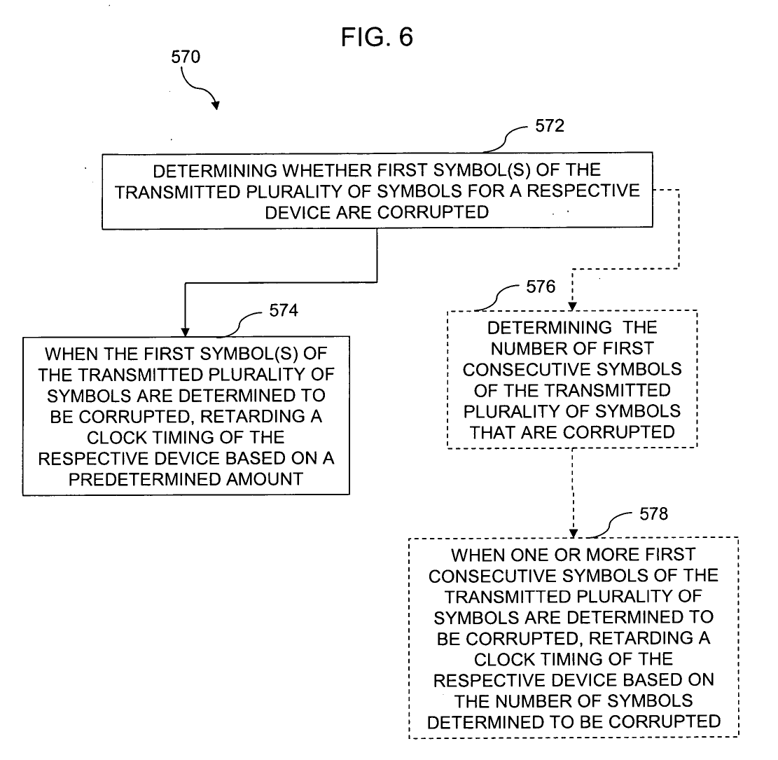

FIG. 5 depicts a flow chart of a control method for synchronizing communications among a plurality of UWB devices in a communication system in accordance with another exemplary embodiment of the present invention. FIG. 6 is a flow chart illustrating an adjustment method for adjusting clock timing of a respective device.

Now referring to FIGS. 5 and 6, at block 510, beacons from the plurality of UWB devices A, B and C in the communication system are detected. In the UWB communication system, each UWB device A, B and C may transmit a beacon during BP 410 of superframe 400, 401 and 402 (See FIG. 4B). Each UWB device A, B and C may detect/monitor beacons of other UWB devices A, B, and C in BP 410 of superframe 400, 401 402. That is, UWB device A, B and C may create its BP 410 by sending a beacon. If one or more beacons of other UWB devices A, B and C are detected, the UWB device A, B and C may synchronize its BP 410 to these detected beacons.

At block 520, each UWB device A, B, and C may determine a TFC for each of the other UWB devices A, B, and C in the communication system according to the detected beacons from the those detected devices.

It is contemplated that the clock of each respective UWB device A, B and C may adjust the timing of its own time reference (e.g., adjust the timing of its clock, to reduce or eliminate clock timing differences between devices). For example, compensation for different clock rates of UWB devices A, B and C may be accomplished by checking timing of BP 410 at the beginning of each superframe and adjusting the transmission to that of the lower clock rate UWB devices. Other clock rate compensation techniques are also contemplated and will be described later in this document.

At block 530, at least some of the UWB devices A, B and C transmitting beacons, may establish a reservation. Each reservation may refer to a respective frame interval 460 to be used to transmit symbols from UWB device A, B and C making the reservation to one or more other UWB devices A, B and C in the communications system. Reservations may be made in one or more reservation blocks 1a, 2a . . . Na; 1b, 2b . . . Nb; or 1c, 2c . . . Nc of DRP 430, shown in FIG. 4B.

At optional block 540, the start of a frame for at least one UWB device A, B and C with respect to one or more other UWB devices A, B and C may be optionally offset according to the detected beacons. By determining the beacon timing of respective devices A, B and C among superframes 400, 401 and 402, frame intervals 460 of each UWB device A, B and C may be synchronized/offset to reduce or substantially eliminate collisions among UWB devices A, B and C, for example, in a band groups 1-4. The frame interval 460 for transmitting one or more symbols for a first UWB device A responding with a beacon may be established by UWB device A in accordance with the determined timing of the beacons established by the other UWB devices B and C. A start of respective frame interval 460 for each successive UWB device B and C responding with a corresponding beacon may be either aligned with that of first UWB device A, or, desirably, offset therefrom according to the established frame interval 460 of first UWB device A responding with the beacon. Offsets to the start of respective frame intervals 460 for successive devices responding with the beacon may be based on a predefined duration, for example, one or more symbol periods or symbol set periods or, otherwise, may be dynamically set based on this predefined duration, adjusted for timing difference due to clock skews (i.e., timing misalignment of slightly unsynchronized clock timing) and propagation delays of the other UWB devices.

At optional block 545, a number of successive (i.e., consecutive) symbols Axx, Bxx and Cxx of UWB devices A, B and C to be transmitted using each respective frequency channel 1-4 may be selected. Because, in such selection, transmission is distributed over 3 sub-bands, its average emission level is ⅓ of that using frequency channels 5-7. Such a selection may be sufficient to maintain an average emission level for the respective UWB devices A, B and C over a set period to less than a threshold value. That is, for example by transmitting M symbols (where M is an integer number) from each UWB device A, B and C using a given frequency band and adjusting the transmission frequency to the next corresponding frequency band and transmitting another M symbols at the next corresponding frequency band and repeating the adjusting and transmitting steps until the communication between or among respective UWB devices A, B, and C are complete, the average emission over a specified time interval for each respective UWB device A, B and C may be maintained.

At optional block 550, each frame interval 460 and intra-frame interval 470 and 480 may be established to include a plural, integral number of symbol periods. That is, by setting a duration of each frame interval 460 and intra-frame interval 470 and 480 to be a plural, integral number of symbol periods, synchronization between UWB devices A, B and C frame-by-frame may be maintained so that collision due to mis-timing of transmissions among the plurality of UWB devices A, B and C may be reduced or substantially eliminated.

It is contemplated that the plural, integral number of symbol periods may be the time-frequency code (TFC) period, for example, a repetition period for the TFC (e.g., 3 symbol periods as illustrated in FIG. 4A). Each intra-frame interval may include either (1) an interval between frames 470 or (2) a guard interval 480 at an end of reservation block 1a, 2a . . . Na; 1b, 2b . . . Nb; or 1c, 2c . . . Nc. Such a structure of reservation block 1a, 2a . . . Na; 1b, 2b . . . Nb; or 1c, 2c . . . Nc ensures that the duration of the reservation block 1a, 2a . . . Na; 1b, 2b . . . Nb; or 1c, 2c . . . Nc for each UWB device/channel is such that frames 460 remain synchronized from either one frame 460 to the next frame 460 or from one reservation block to the next reservation block.

At block 555, the transmission (frequency) band of each respective UWB device A, B and C may be adjusted according to the determined TFC. Each TFC defines the number of frequency bands and the order of those frequency bands to be used. Different channels have different order of band usage. Each piconet may choose one operating channel that is different from other piconets to avoid collision. Because band group 1 has the longest coverage range of the plurality of band groups 1-5 due to its lower transmission frequencies, and is the easiest implementation among the plurality of band groups 1-5, band group 1 may become the most highly used in deployments, in particular, for initial deployments. As there are only 3 frequency bands in band group 1, typically 3 SOPs may be supported simultaneously, assuming they are synchronized or substantially synchronized. It is contemplated, however, that any number of SOPs may share a lesser number of frequency bands by turning off transmission at selected times (e.g., by synchronizing the timeframes in which they do not transmit symbols). That is, for example, 4 SOPs may share 3 frequency bands, for example, by rotating when each respective SOP may not transmit symbols such that only three of the four SOPs transmit at any given time.

The TFC for each UWB device A, B and C in the communication system may be determined according to an order of response of the detected beacons from the plurality of UWB devices A, B and C by matching first UWB device A to respond with a beacon to a first frequency band (for example band 1) and subsequent UWB devices B and C to other respective bands (for example band 2 and 3, respectively) according to the number of frequency bands in the band group. It may be desirable to have the same number or fewer UWB devices than frequencies bands in the band group 1-4. For example, the TFC may include rotating the transmission frequency among a plurality of frequency bands for each UWB device while transmitting one or more symbols from these devices (and desirably a plurality of symbols for each device) at each of the rotated transmission frequencies such that simultaneous transmissions by respective UWB devices are at different transmission frequencies.

Each of the UWB devices A. B and C that responds with a beacon may be set to transmit symbols according to a corresponding channel of band group 1-4. That is, the TFC may establish a time-frequency hopping scheme coordinated among UWB devices A, B and C in band group 1-4 to repeatedly adjust the frequencies for transmission of one or more successive (consecutive) symbols until, for example, the communication from respective devices A, B and C are completed.

At block 560, during frame interval 460, symbols may be transmitted, for example, by OFDM techniques or other time-frequency hopping techniques used in multi-band communication systems. Each transmissions of symbols may be a transmission of a set of successive (consecutive) symbols representing portions of a communication, as information bits. Portions of these symbols may be redundant (contain the same information bits) to increase reliability of the communication and/or portions may represent different successive data (contain different information bits) of the communication. That is, each set of symbols may include, for example, successive symbols representing successive information bits of a respective communication and/or repeated symbols representing repeated information bits of the respective communication.

Certain embodiments of the present invention may include timing adjustments to clock rates to limit the effect of clock rate mis-alignment between or among device.

At optional block 570, clock timing may be adjusted (for example, to reduce the effects of clock skew) for respective UWB devices A, B and C. By determining which one or ones of the transmitted plurality of symbols transmitted using the adjusted frequency band are corrupted (e.g., have decoded signals that are degraded), clock timing of the respective device may be adjusted. That is, the clock timing of the respective device may be adjusted, for example, by: (1) advancing the clock timing of the respective device, when a last symbol of the transmitted plurality of symbols (the symbol set) is corrupted; (2) retarding the clock timing of the respective device, when a first symbol of the transmitted plurality of symbols (the symbol set) is corrupted. The amount of advancement or retardation may desirably correspond to the number of symbols that are determined to be corrupted. For example, the advancement of the clock timing may be by an amount corresponding to at least a number of symbols at an end of the transmitted plurality of symbols that are determined to be corrupted or the retardation of the clock timing may be by an amount corresponding to at least a number of symbols at a start of the transmitted plurality of symbols that are determined to be corrupted. By providing such clock timing adjustment, it is possible to reduce or substantially eliminate the effects of different clock skews producing corruption (collisions) of symbols between or among UWB devices due to the symbols being slightly unsynchronized.

As best illustrated in FIG. 6, block 570 may include the steps of determining whether a first symbol in a symbol set or a beginning (start) portion of a symbol set (i.e., a certain number of symbols of a beginning portion of the symbol set) for a respective device is corrupted at block 572 and when the first symbol or the beginning of a symbol set (the symbol set being the transmitted plurality of symbols) is determined to be corrupted, retarding a clock timing (i.e., clock rate) of the respective device based on a predetermined amount, at block 574.

Optionally, the number of consecutive symbols of the symbol set symbols that are corrupted may be determined, at block 576 and when one or more first consecutive symbols of the transmitted plurality of symbols are determined to be corrupted, the clock rate of the respective device may be retarded based on the number of symbols determined to be corrupted, at block 578.

In FIG. 5 at block 580, it may be determined whether the communication between or among UWB devices A, B, and C is complete. If communication is determined to be complete, communication may end at block 590 or additional communications (not shown) between or among UWB devices A, B and C may be initiated based on the established reservations. That is, the process may continue at block 555 for a next reservation. If communication is determined to not be complete, the process may continue at block 555. That is, each UWB device A, B and C may time-frequency hop to a different logically sequenced frequency band and may transmit a plurality of symbols (i.e., a set of symbols) at each different frequency band according to the TFC. This process of adjustment at block 555 and transmission at block 560 may be repeated until communication between one or more UWB devices A, B and C are completed.

Collisions (i.e., corruption) among or between symbols from two or more different UWB devices A, B and C may occur when two or more UWB devices A, B and C simultaneously communicate on a common frequency band (e.g., some portion of the transmission from UWB devices A, B and C occurs simultaneously at the same frequency band).

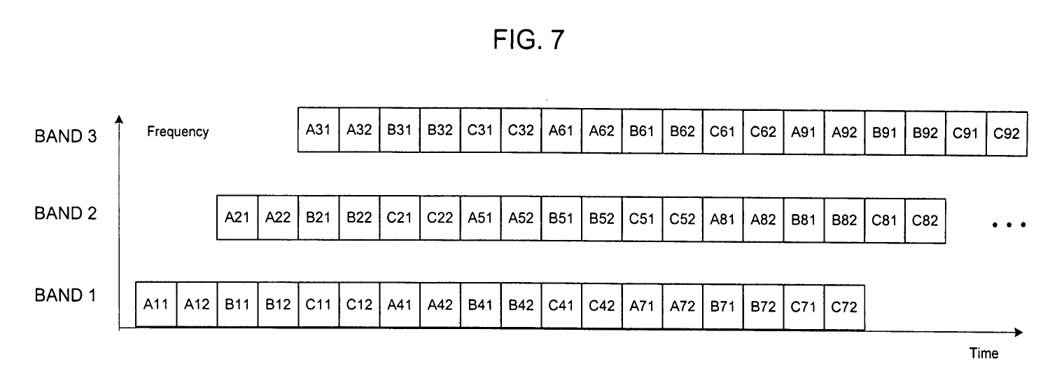

In FIGS. 7, 10-11 and 13-15 each box represents a symbol, for example, symbol A12 represents a symbol transmitted by UWB device A, as the second successive (consecutive) symbol from symbol set 1 and symbol C91 represents a symbol transmitted by UWB device C, as the first successive (consecutive) symbol from symbol set 9.

FIG. 7 is a timing diagram illustrating an exemplary communication from UWB devices using the TFCs shown in FIG. 4A according to an embodiment of the present invention. By implementing the exemplary TFCs of FIG. 4A and ensuring synchronization of the frames of each UWB device A, B and C in band group 1-4, throughput may be increased and collisions between transmissions may be reduced or substantially eliminated.

Referring now to FIG. 7, UWB device A may transmit sets of symbols (e.g. sets A1-A9) using channel 1 of the TFC of FIG. 4A (i.e., sequencing through frequency bands 1, 2 and 3); and UWB device B may transmit sets of symbols B1-B9 using channel 2 of the TFC of FIG. 4A; and UWB device C may transmit sets of symbols C1-C9 using channel 3 of the TFC of FIG. 4A. In such a case, symbols from a UWB device in a set or from different sets may include redundant content (i.e., repeat information bits to increase reliability of the transmission). That is, symbols may be repeated on the same or a different transmission frequencies (i.e., frequency and/or time-domain spreading): (1) to reduce or substantially eliminate the effect of clock skews of different UWB devices; (2) to increase overall transmission success due to symbols being corrupted from, for example, NBI; (3) to maximize frequency diversity; and (4) to improve performance in the presence of other non-coordinated UWB devices. Moreover, such repetition of symbols are not required. Further, symbols may be repeated any number of times.

Although FIG. 7 illustrates symbol sets of two symbols (e.g., A11 and A12, B11 and B12 . . . ), it is contemplated that symbol sets may be any number of plural symbols. The number may be desirably set to reduce average emissions from each UWB device over a frequency band to below a threshold so that these UWB devices do not interfere with other devices, such as fixed frequency and frequency hopping devices, among others. Further, the number of successive symbol in a symbol set may vary responsive to the condition that timing between devices remains synchronized. That is, if the duration of respective symbol sets from each device (i.e., simultaneously transmitted symbol sets) is the same, their synchronization may be maintained even if the duration of subsequent symbol sets vary in duration.

When UWB devices in the same piconet (i.e., channel of a band group) are arranged to synchronize (e.g., coordinate) with other piconets, channel capacity may be increased without collision. If a plurality of UWB devices use a common TFC and each subsequent UWB device starts transmission with an offset of one-symbol set, a common duration of each symbol set or a duration which is an integer multiple of each symbol set, collisions may be reduced or substantially eliminated. For example, in band group 1, using the TFCs of FIG. 4A, three UWB devices may be multiplexed without collision. That is, the DRP may be allocated based on symbol set offset (i.e., symbol set level multiplexing) within channels.

To achieve such symbol set offset, a unit smaller than a symbol set may be used. Because symbols in time-domain include of a plurality of samples, symbols and/or samples may be used as a basic unit to achieve this symbol set offset. A new Information Element (IE) may be used to achieve this symbol set offset and other timing adjustments.

In other words, to achieve band multiplexing, devices sharing the same reservation block 1a, 2a . . . Na; 1b, 2b . . . Nb; or 1c, 2c . . . Nc may start from different symbols to avoid collision. Starting symbols (e.g., to provide symbol set offset) for each UWB device A, B and C in a band group may be controlled and the symbol set offset may be announced in the BP 410 in addition to the reservation block 1a, 2a . . . Na; 1b, 2b . . . Nb; or 1c, 2c . . . Nc and channel C1-C3 of the UWB device A, B and C. Symbol set offset may occur only once at the start of DRP, and only the first frame 460 in DRP may be offset. Subsequent frames 460 in DRP follow the established TFC. For example, if the TFC is 3 symbol set periods, offset of UWB devices A, B and C sharing a band group may be set to between 0 to 2 symbol set periods.

DRP reservation 430 may be aligned to reservation block 1a, 2a . . . Na; 1b, 2b . . . Nb; or 1c, 2c . . . Nc. Different UWB devices A, B and C may start from different reservation blocks 1a, 2a . . . Na; 1b, 2b . . . Nb; or 1c, 2c . . . Nc but multiplexed in the same band group. To ensure these devices which share a common reservation block starting with a common symbol set offset, the reservation block may be an integer N number of TFCs in duration.

By synchronizing transmission of frames and providing a rotating time-frequency hopping scheme, the throughput for a SOP can be increased while reducing or substantially eliminating collisions from other SOPs.

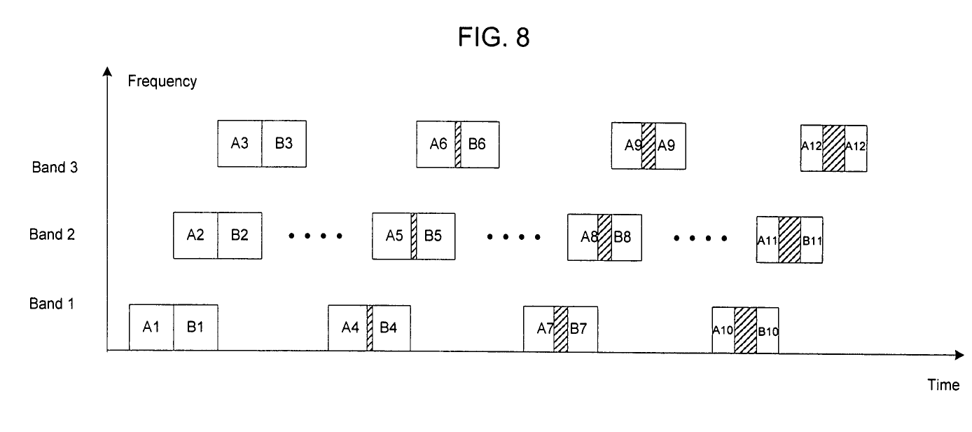

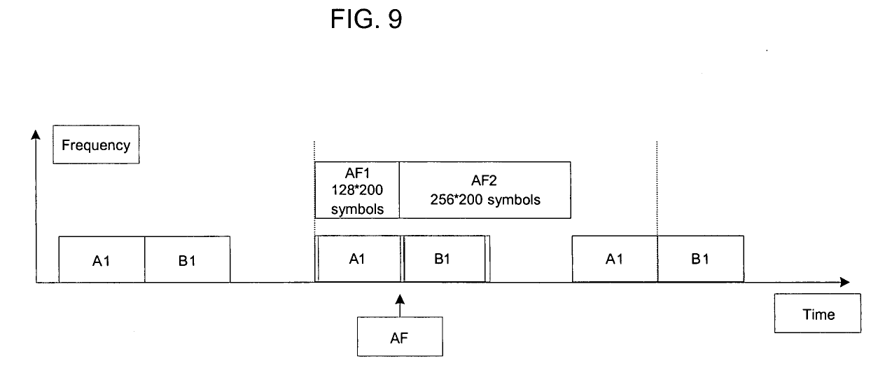

FIGS. 8 and 9 are timing diagrams illustrating collisions between two devices in a multi-band communication system when the devices have slightly unsynchronized clock timing.

Now referring to FIGS. 8 and 9, A and B represent devices and each block represents a symbol. Cross-hatching denote collisions between symbols that may produce a corruption (i.e., coincident transmission from the devices on a common frequency band). Although collisions may occur in some of the symbols on some frequency bands, it may be possible to recover these symbols based on, for example, forward error correction techniques.

It is desirable to achieve and maintain timing alignment between UWB devices A and B to reduce or substantially eliminate collisions due to clock skew (i.e., timing misalignment of slightly unsynchronized clock timing). Symbols may be very short in duration (e.g., in the range of less than 1 μs) in, for example, OFDM systems that are symbol level multiplexed. High performance clock hardware may be used to maintain timing alignment between UWB devices A and B. Low performance hardware, e.g., low performance clock hardware, however, is commonly used in consumer electronics to reduce cost. The low performance hardware generates a clock rate that may be skewed. That is, any two devices, for example UWB devices A and B, may have different clock rates. Such clock skews may result in periodic symbol overlap or symbol collision.

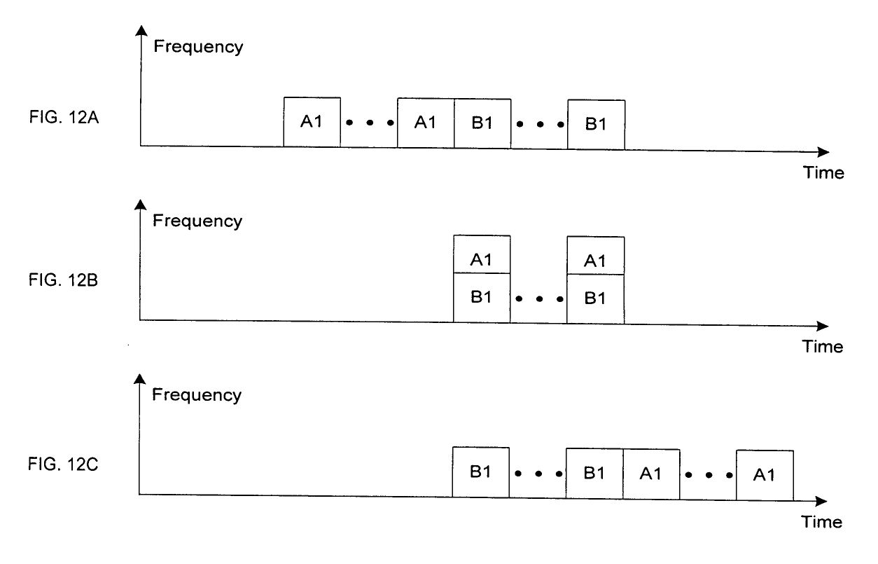

In FIG. 8 symbols A1 and B1, A2 and B2, and A3 and B3 are respectively aligned without overlap. Symbols A4 and B4, A5 and B5, and A6 and B6 may overlap due to different clock rates used in UWB devices A and B. This overlapping effect is more pronounced (i.e., the overlap becomes greater over time until symbols from UWB device B move past (catch up to those of UWB device A). That is, symbols A7 and B7, A8 and B8 and A9 and B9 overlap more (i.e., have a greater percentage overlap) than symbols A4 and B4, A5 and B5, and A6 and B6, respectively. Such an overlapping effect is described below with reference to FIGS. 12A-12C. This overlapping effect due to clock skew causes, for example, collisions between respective symbols, and corruption of these symbols. The corruption may produce a need to retransmit these symbols.

For typical commercial consumer electronics devices, hardware may be used having a maximum clock skews in the range of less than 40 part-per-million (ppm) and desirably less than 20 ppm. If, for example, UWB devices A and B operate with a carrier frequency of 4 GHz and maximum clock skews of 20 ppm, the maximum difference between clock rates of UWB devices A and B is 0.0040%. In one second, the maximum frequency difference is 160 kHz as shown by equation (1).

$$Δ = 4 GHz \times \frac{0.0040}{100} = 160 kHz \qquad ( 1 )$$

This frequency difference is equivalent to a time difference of 40 μs as shown by equation (2).

$$Δ = \frac{106 KHz}{4 GHz \text{/} sec} = \frac{160}{4 * {10}^{6}} sec = 40 us \qquad ( 2 )$$

If each symbol has, for example, a duration of 250 ns, and includes 128 samples, each sample is about 2 ns in duration and the frequency difference may be converted into a difference in the number of symbol between each of the UWB devices A and B of 160 symbols per second as shown in equation (3).

$$Δ = \frac{40 us}{250 ns} = 160 symbol \text{/} sec \qquad ( 3 )$$

That is, in one second, the clock difference between two UWB devices A and B with 4 GHz carrier frequency and 250 ns symbol durations using 20 ppm hardware may cause a maximum time difference equivalent to about 160 symbols. Thus, a one-symbol difference may occur in about 1/160 seconds. A one-sample difference may occur in about 1/(160*128) seconds (or a minimum of about 200 symbols in duration).

For this exemplary case, it may take a minimum of at least about 200 symbols to generate 1 sample difference between UWB devices A and B. Although UWB devices A and B may be aligned at symbols A1 and B1, A2 and B2 and A3 and B3, after about 200 symbols, their symbols may become overlapped by 1 sample. The number of overlapped samples may increment by as much as 1 sample for every additional 200 symbols transmitted. Since superframe 200 may include about 2.62×10⁵ symbols, the maximum time difference (clock mis-alignment) in samples using an overlap of 1 sample per 200 symbols is 1.3×10³ samples.

As shown in FIG. 9, if AF denotes the front edge of symbol from device A, when AF falls in zones AF1, there is no sample overlap between UWB device A and UWB device B and when AF falls in zones AF2, sample overlap occurs. Zone AF1 may be one symbol length while AF2 may be two-symbol lengths. In this case, it may take 128*200 symbols for the AF to cover one symbol length. Since AF1 is half as long as AF2, sample overlap occurs 66.7% of total time.

In multi-band communication UWB receivers using OFDM for example, symbols in the time domain are converted via a fast fourier transformer (FFT) into symbols in frequency domain. A decision is made in the frequency domain on each carrier. The FFT spreads any sample corruption in the time domain to all sub-carriers. Thus, sample corruption may affect all sub-carriers or may affect the entire symbol for a UWB device. Moreover, 33.3% of the time two UWB devices A and B may be free of overlap and 66.7% of the time the two devices may collide.

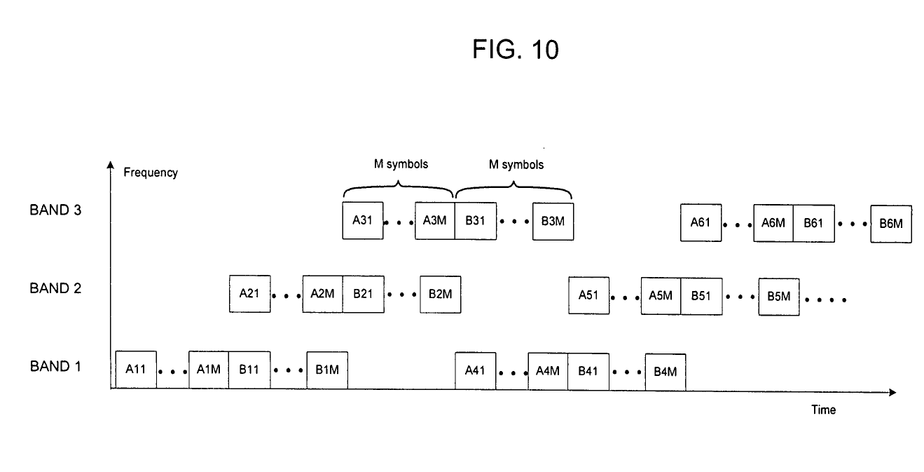

FIG. 10 is a generalized timing diagram illustrating timing of symbols for two devices in a multi-band communication system in accordance with yet another exemplary embodiment of the present invention when the devices have synchronized clock timing;

Referring to FIG. 10, UWB device A may transmit M consecutive symbols, for example, as symbol set A1 that includes symbols A11 . . . A1M. In the exemplary embodiment shown in FIG. 10, UWB device A may transmit using frequency band 1 and then switch (adjust) to frequency band 2. UWB device B, synchronized with UWB device A may transmit M consecutive symbols, for example, as symbol sets B1 that includes symbols B11 . . . B1M immediately after UWB device A transmits symbol A1M. In this exemplary embodiment, UWB device B transmits using frequency band 1 and then switches (adjusts) to frequency band 2. That is, band multiplexing is based on a unit of M symbols, as symbol sets. Each of the symbol sets A1-A6 and B1-B6 may include successive (consecutive) symbols (i.e., different symbols) representing successive data (information bits) of a respective communication between UWB devices A and B and/or repeated symbols (i.e., the same symbol) representing repeated data of the respective communication.

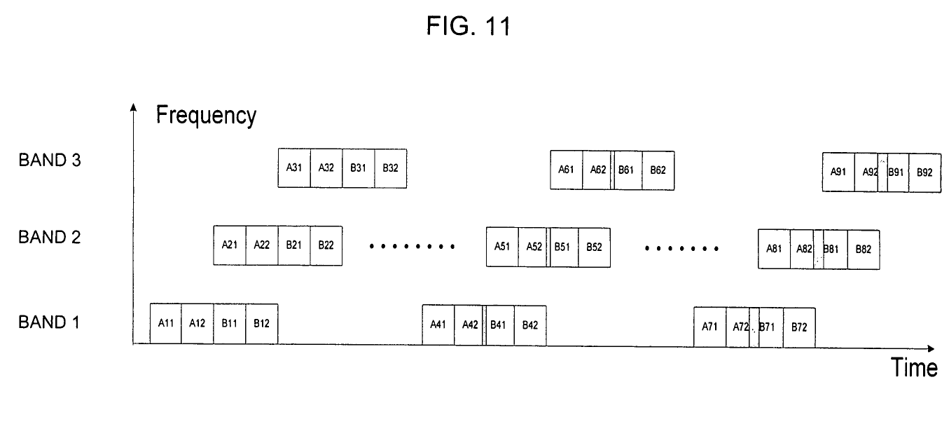

FIG. 11 is a timing diagram illustrating timing of symbols for two devices in a multi-band communication system in accordance with yet another exemplary embodiment of the present invention when the devices have slightly unsynchronized clock timing;

FIG. 11 illustrates the same frequency hopping scheme (TFC) shown in FIG. 10 with M equal to 2 and slightly unsynchronized clocks, for example in a range of less than 40 ppm, and desirably less than 20 ppm. UWB devices A and B transmit symbol sets A1-A9 and B1-B9, respectively, on rotating frequency bands 1-3.

Since M symbols of a symbol set may be transmitted in the same frequency band 1-3, 1/M of the total symbols may be corrupted during a specified time corresponding to a certain number of transmitted symbols, as an example 200 symbols to 128*200 symbols for clock hardware having a 20 ppm accuracy. In this case, the overlap rate of symbols in FIG. 11 is 1/M (or 50%) which is a decrease from a 100% overlap rate shown in FIG. 8. Table 1 shows the overlap rate for different value of M for the 200^{th} symbol to the first 128*200 symbols in duration. As M increases, the percentage of affected symbols decreases, however, as M reaches infinite (i.e., UWB devices A and B never switch to another band and assuming each UWB device A and B starts from different frequency bands), emissions may be required to be reduced by 4.7 db to conform with FCC requirements.

Table 1. Overlap rate for different values of M during first interval from 200 symbol to 128*200 symbols.

| | Overlap rate (%) |
|---|---|
| M | (1-128) * 200 symbols |
| 1 | 100.0 |
| 2 | 50.0 |
| 3 | 33.3 |
| 4 | 25.0 |
| 5 | 20.0 |
| 6 | 16.7 |

That is, after a time lapse corresponding to about 200 symbols, symbols from UWB devices A and B overlap for 66.7% of the time. In the system illustrated in FIG. 8, once collision occur, the collisions affect all symbols, i.e., 100% of the symbols.

FIGS. 12A-12C are timing diagrams illustrating collision patterns of symbols for two UWB devices A and B on a single frequency band when the devices have slightly unsynchronized clock timing. Although in FIG. 12B symbol set A1 is shown above symbol set B1, for illustrative purposes, they are being transmitted on the same frequency (e.g., the same frequency band).

Referring to FIGS. 12A-12C, when UWB devices have slightly unsynchronized clock rates (i.e., clock timing) due to clock skews for example, the relative timing of symbols from UWB device A occurs at a slightly different time for each transmission using a particular frequency band. FIGS. 12A-12C show an exemplary sequence of timeframes to illustrate relative timing of transmission of UWB devices A and B. FIG. 12A illustrates a first timeframe (phase 1) in the sequence and shows a relative timing of transmission of UWB device A being just prior to that of UWB device B. No collision due to clock timing occurs in phase 1. In a second timeframe (phase 2) in the sequence (either an earlier or a later timeframe than phase 1), FIG. 12B illustrates that the relative timing of transmissions of UWB devices A and B is simultaneous and 100% of the symbols in a symbol set collide and may be corrupted. In a third timeframe (phase 3) in the sequence, FIG. 12C illustrates that the relative timing of transmission of UWB device A is just after that of UWB device B and no collision due to clock timing occurs in this phase 3. When phase 1 of FIG. 12A is earlier than phase 2 of FIG. 12B and phase 2 is earlier than phase 3 of FIG. 12C, each clock period of UWB device A is longer than that of UWB device B (i.e., the clock rate of UWB device A is slower than that of UWB device B). Thus, the timing of UWB device B may be adjusted (reduced) to match that of UWB device A. Conversely, when phase 1 is later than phase 2 and phase 2 is later than phase 3, each clock period of UWB device A is shorter than that of UWB device B (i.e., the clock rate of UWB device A is faster than that of UWB device B), and the timing of UWB device A may be adjusted (reduced) to match that of UWB device B.

In the case of a UWB communication system having 250 ns symbol duration and 20 ppm hardware, each 128*200 symbol duration refers to a different phase (i.e., phases 1-3) which relates to different collision patterns. That is, there are three phases, i.e., a first phase in which UWB device A just starts to enter overlap with UWB device B, a second phase in which UWB device A completely overlaps with UWB device B and a third phase in which UWB device A just starts to enter an overlap free state relative to UWB device B. In transitioning from the first phase to the second phase, the number of overlapped symbols increases by 1 for a specified duration of time (e.g., a 128*200 symbol duration) and in transitioning from the second phase to the third phase, the number of overlapped symbols decreases by 1 for the same specified duration of time. Table 4 lists average overlaps for different value of M. The average collision rate (excluding the duration without symbol overlap) may be calculated in the following way.

Since it takes M increments for a UWB device using a frequency band transmitting M consecutive symbols to migrate from the first phase to the second phase, and (M−1) increments to migrate from the second phase to the third phase, the total number of increments to migrate from the first phase to the third phase is 2M−1. During each increment, M symbols are involved for UWB device A, and the total number of symbols involved is M(2M−1). The number of overlapped symbols for UWB device A may be calculated as shown in Equation (4).
1+2+ . . . +(M−1)+M(M−1)+ . . . +2+1=M² (4)
The average overlap rate may be calculated as shown in Equation (5).

$$\begin{matrix}\frac{Overlap symbols}{Total symbols} = \frac{ {M}^{ 2}}{ M ( 2 M - 1 )} \\ = \frac{M}{ 2 M - 1} \\ = \frac{M}{ 2 M - 1} > \frac{M}{ 2 M} \\ = 50 \%\end{matrix} \qquad ( 5 )$$

Table 2 illustrates the average overlap rate for different values of M.

| | Average overlap rate |
|---|---|
| M | (%) |
| 1 | 1/1 = 100.0% |
| 2 | 2/3 = 66.6% |
| 3 | 3/5 = 60.0% |
| 4 | 4/7 = 57.1% |
| 5 | 5/9 = 55.5% |
| 6 | 6/11 = 54.5% |

As the number of consecutive symbols M in a symbol set increases the average overlap rate quickly approaches 50%. When M approaches or substantially approaches infinite (i.e., when the number of consecutive symbol approaches infinite), frequency hopping does not occur and if UWB devices A and B start on different frequency bands 1-3, collision between UWB devices A and B may be avoided. Because such consecutive symbols of a symbol set, for example, from UWB device A are transmitted on the same frequency band, for example frequency band 1, total transmission power is accumulated, with a result that an emission level may be 4.7 dB higher than if distributed over three frequency bands 1-3. Correspondingly, transmitters may be required to reduce transmission power by 4.7 dB to meet certain FCC regulations. Reduced transmission power may result in reduced coverage range. It is desirable that the number of consecutive symbols of each symbol set not be set too large (e.g., at or close to infinity) so that transmission power from a UWB device may be increased, for example, to increase coverage range. Moreover, average emission level of a UWB transmitter is measured to increase by the Power Spectral Density (PSD) and the PSD may be required to be below −41.25 dBm/Mhz based on FCC regulations. The average emission level may be measured by a Root Mean Squared (RMS) calculation for the transmission signal over a 1 ms duration. To distribute emission over 3 frequency bands during the 1 ms duration, M may be selected as shown in Equation 6.

$${M}^{*} 250 ns < \frac{1}{3} ms or M < \frac{{10}^{- 3}}{250 * 3 * {10}^{- 9}} \approx 1.3 K \qquad ( 6 )$$

That is, with 250 ns symbol durations, M may be desirably set to less than about 1.3×10³ symbols (i.e., a maximum symbol set) to distribute symbols over 3 frequency bands in a 1 ms duration. Thus, it may be desirable to limit M ( i.e., number of symbols transmitted consecutively using a frequency band) to a range less than about 2000 symbols to maintain full transmission power of a respective UWB device without back off to meet the FCC's emission mask.

Although the maximum symbol set is shown to be about 1.3×10³ symbols, it is contemplated that the maximum symbol set may vary with the measured duration, the number of frequency bands involved and the duration of each symbol. Moreover, the maximum symbol set is not a limitation on the size of the symbol set but may result in a reduced emission power of the transmitted signal from a UWB device.

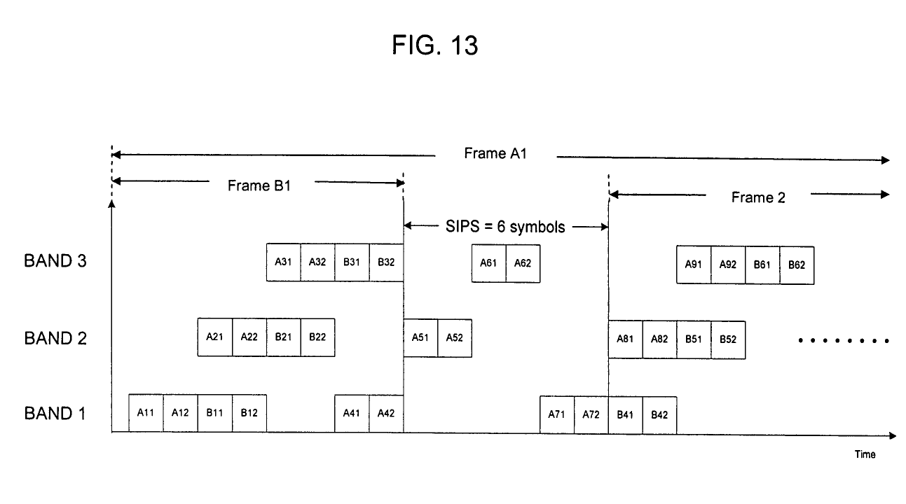

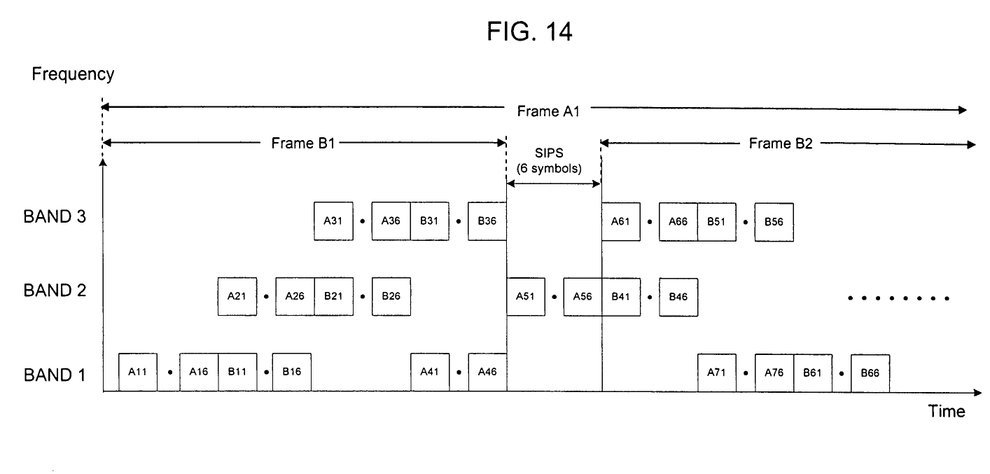

FIGS. 13 and 14 are timing diagrams illustrating inter-frame periods in accordance with further exemplary embodiments of the present invention.

Now referring to FIGS. 13 and 14, to maintain symbol alignment it may be desirable to provide intra-frame periods, such as intra-frame intervals 470 and 480 shown in FIG. 4, that are integer multiples of a symbol duration or a symbol set duration. Intra-frame periods may be selected to be, for example, 6 symbols. In such a case, to maintain symbol alignment, M may be 2 symbols, 3 symbols or 6 symbols in duration.

FIGS. 13 and 14 illustrate symbol alignment for M=2 and M=6, respectively. In FIGS. 13 and 14, UWB device A transmits in a frame A1 (i.e., a single frame) while UWB device B transmits in frames B1 and B2 with a gap of SIPS, 6 symbols in duration, in between frames B1 and B2.

In FIG. 13, UWB device B may start using one frequency band, for example frequency band 1, rotate transmission frequencies corresponding to, for example, channel C2 in frame B1 and have an SIPS gap (i.e., an interframe period of 6 symbols). The next transmission may start again on frequency band 1 and rotate transmission frequencies in frame B2. That is, UWB device B may start on a common frequency band 1 in a subsequent frame (i.e., the next frame). For the case of M=2, UWB devices may start from the same (common) frequency band 1 in future frames. Simultaneous with frames B1, and B2 and the interframe period, UWB device A, may transmit on a different channel, for example, channel C1.

In FIG. 14, UWB device B may start using one frequency band, for example frequency band 1 for frame B1 and another frequency band, the next frequency band in the logical succession of frequency bands, in this case frequency band 2 for the subsequent frame (e.g., frame B2). That is, in the case of M=6, UWB devices may start from a frequency band incremented circularly from a previous frequency band for subsequent frames.

A large portion of the time, for example, a system of two devices work in a collision state. Collision may be treated as equivalent to noise that reduces a signal-to-noise ratio (SNR) and degrades performance. Certain embodiments of the present invention may reduce the percentage of corrupted symbols, and/or may reduce the average number of corrupted symbols to improve performance in terms of SNR, for example, by timing adjustments to clock rates to improve synchronization of UWB devices with clock skews.

FFT spreads sample corruption in the time domain to all sub-carriers. Since some sub-carriers are reserved as pilot tones, for example, in a Multi-Band (MB) OFDM system, the pilot tones may be corrupted. The pilot tones may be used to detect collisions, however, such detection may only occur in the frequency domain. When continued quality degradation is detected for these pilot tones, a determination is made that collisions are occurring. For the MB-OFDM system shown in FIG. 7, as an example, it is difficult or impossible to distinguish which of the samples in the time domain may be corrupted (e.g., in which direction collisions start). In various embodiments of the present invention, for example as illustrated in FIGS. 10 and 11, the place where collisions start may be determined in terms of symbols (at the sample or symbol level). For example as shown in FIG. 11, a collision starts from a second symbol of symbol set A4 (i.e., A42), i.e., collision on the second symbol in frequency band 1 for UWB device A and a first symbol of symbol set B4 (i.e., B41) in frequency band 1 for UWB device B. Signal quality of these two symbols A42 and B41 for common frequency band 1 may be different than other symbols on the same frequency band 1 when the collision occurs. Moreover, the signal quality of these two symbols A42 and B41 for common frequency band 1 may be different when collisions are occurring relative to when collisions are not occurring. That is, symbols, for example A42, A52, A62, A72, A82, A92, B41, B51, B61, B71, B81 and B91, subject to collision may exhibit lower signal quality than other symbols that are not in collision. If the first symbol experiences a lower signal quality than other symbols, a collision may be indicated for the first symbol, otherwise the collision may be indicated for a last symbol in a symbol set. For M=2 the last symbol in the symbol set is the second symbol in the symbol set as shown in FIG. 11.

By determining which symbols are colliding, time adjustment may be performed in any number of ways. For example, the timing of one of the two UWB devices A and B in collision may be adjusted (e.g., the timing of the slower clock rate device may be increased to synchronize its timing to that of the faster clock rate device or, desirably the timing of the faster clock rate device may be decreased to synchronize its timing to that of the slower clock rate device). Moreover, the actual amount of the timing adjustment desirably may be equal to at least the duration of the number of corrupted consecutive symbols of a symbol set for the UWB device having its timing adjusted. Other timing adjustments are also contemplated which may adjust clock synchronization differences.

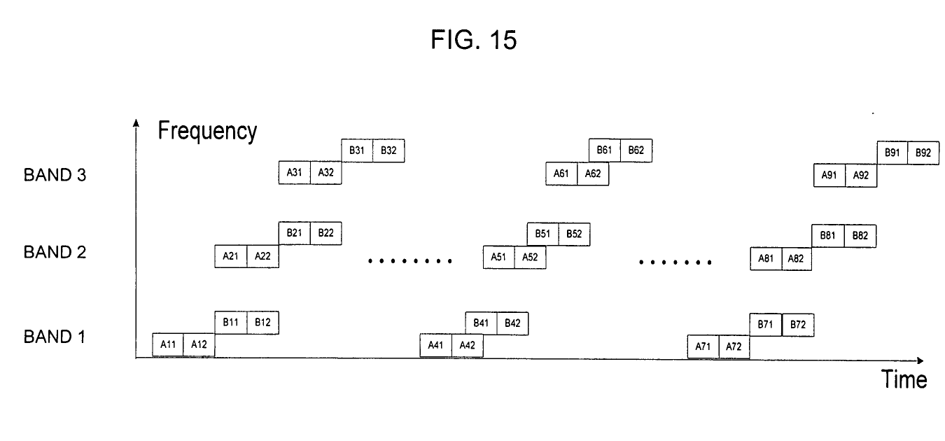

FIG. 15 is a timing diagram illustrating timing adjustments in accordance with yet another embodiment of the present invention.

As illustrated in FIG. 15, UWB device B initially with a faster clock rate relative to UWB device A may adjust to UWB device A by decreasing the rate of its clock. If the first symbol in a symbol set transmitted by UWB device B is corrupted (e.g., B41, B51 or B61), the clock rate of UWB device B may be determined to be faster than that of UWB device A and timing of UWB device B may be retarded. Moreover, if a last symbol of a symbol set transmitted by UWB device A is corrupted (e.g., A42, A52 or A62), the clock rate of UWB device A may be determined to be slower than that of UWB device B. In such a case, the timing of UWB device A may be maintained, thereby allowing UWB device B to synchronize with UWB device A.

Although the timing of UWB device B is adjusted and UWB device A is maintained in the above-example, it is contemplated that either one or both of the timings of UWB devices A and B may be adjusted so long as the adjustment tends to bring the synchronization of UWB devices back into alignment, since the system is then self correcting over a plurality of transmissions.

With such an adaptive timing adjustment, timing difference may be limited to one symbol or less in duration such that corrupted symbols of a symbol set have M consecutive symbols may be limited to a ratio at or below 1/M.

Although timing adjustments are shown in FIG. 15 which are less than one symbol in duration, it is contemplated that, if collisions occur that affect more than one symbol of a symbol set, the timing adjustment may be more than one symbol and may be, for example, substantially proportional to or correspond to the duration of the corrupted symbols and/or samples of the symbol set. That is, if N symbols of UWB devices A are subjected to collision by N symbols of UWB devices B where N is less than M, UWB devices A and B may detect degradation in the demodulation of either or both of these N symbols of UWB devices A and B. If UWB device B has a faster clock rate than that of UWB device A, the N symbols are at the beginning of each symbol set for UWB device B and at the end of each symbol set for UWB device A, and UWB device B may retard its transmission by at least N+1 symbols to prevent further collisions. If UWB device A has a faster clock rate than that of UWB device B, the N symbols are at the beginning of each symbol set UWB device A and at the end of each symbol set for UWB device B and UWB device A may retard its transmission by at least N+1 symbols to prevent further collisions. To prevent collision for certain time, (related to, for example, intra-frame periods) transmission may be retarded by more symbols than N+1.

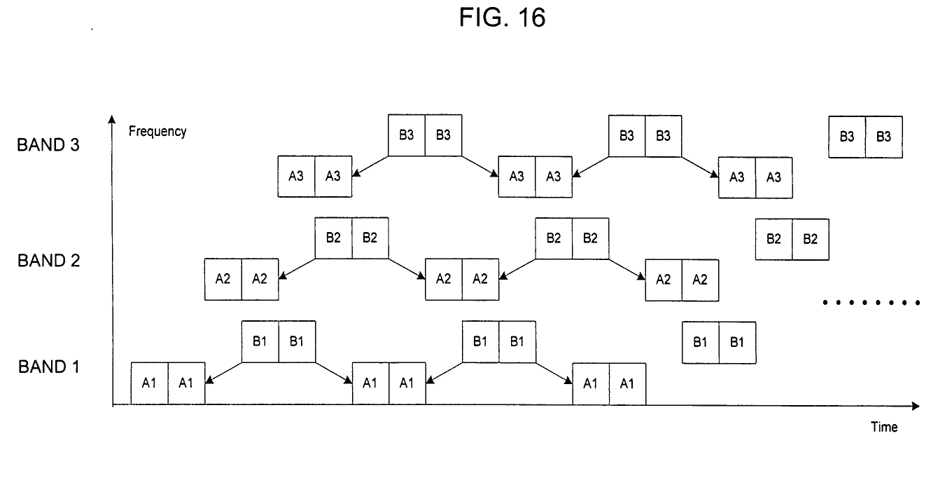

FIG. 16 is a timing diagram illustrating timing adjustment in accordance with yet another embodiment of the present invention.

Referring to FIG. 16, band group 1, as an example, may accommodate three UWB devices at the same time without collision and if two UWB devices A and B use the frequency bands in band group 1, there is available capacity in band group 1 for timing adjustments That is, if M=2, i.e., two symbols are transmitted consecutively on the same band before hopping to another band, and the timing of UWB device A is fixed, there are 4 symbol spaces to accommodate 2 symbols of UWB device B such that UWB device B has flexibility in timing adjustments to avoid collision with UWB device A.

Referring back to FIG. 7, in this exemplary embodiment of the present invention, when three UWB devices A, B and C are transmitting consecutively on each respective frequency band 1-3 such as those in band group 1, there is no additional frequency band capacity. If UWB device B has the fastest clock rate and UWB device A has the slowest clock rate, UWB device B may catch up to and overlap with UWB device A. At the same time, UWB device C cannot catch up with UWB device B so there is no overlap between UWB devices B and C. When one or more symbols of UWB device B collide with those of UWB device A, UWB device B may retard its transmission. Since UWB device B may align its clock timing to (i.e., synchronize with) that of UWB device A, symbols of UWB device B may eventually collide with UWB device C. When UWB device C determines that a first symbol is overlapped (i.e., the first symbol in a symbol set is corrupted) UWB device C may retard its transmission.

Since with three UWB devices A, B and C, there is no additional system capacity, the three UWB devices A, B and C desirably may be closely aligned/synchronized (e.g., having less timing misalignment than one sample) to avoid such collisions.

According to certain embodiments of the present invention, a band hopping sequence is provided to achieve symbol level band multiplexing in the frequency domain for UWB systems. The sequence may reduce requirement of accuracy for clock hardware and may reduce initial collision rates. When collisions occur, which symbols are effected at collision start may be detected and corresponding timing adjustment may be preformed to reduce or substantially eliminate such collisions in subsequent transmissions. That is, collision rates may be upperly bounded to 1/M symbols where M is the number of consecutive symbols in a symbol in a symbol set for each respective frequency band.

Although the system has been illustrated as a UWB system, it is contemplated that certain embodiments of the present invention may be applied in other distributed networks (e.g., ad hoc networks) where no central controllers are used.

As is readily understood from these figures, if symbols between devices/channels/SOPs are not aligned, collision patterns may be increased reducing performance of the communication system. Moreover the term “slightly unsynchronized” refers to a mis-alignment in the timing of a plurality of devices which is a portion of a symbol in duration.

Although the invention has been described in terms of a UWB multi-band communication system, it is contemplated that it may be implemented in software on microprocessors/general purpose computers (not shown). In various embodiments, one or more of the functions of the various components may be implemented in software that controls a general purpose computer. This software may be embodied in a computer readable carrier, for example, a magnetic or optical disk, a memory-card or an audio frequency, radio-frequency, or optical carrier wave.

In addition, although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A control method for synchronizing communications between or among a plurality of devices in a communication system including a plurality of frequency bands used for communications; the method comprising the steps of:
a) detecting beacons from the plurality of devices in the communication system;
b) establishing respective reservations for at least a portion of the plurality of devices in the communication system, each reservation being a frame interval in which to transmit symbols from one device to one or more other devices in the communications system;
c) determining, by each device, a time-frequency code for each of the other devices in the communication system according to the detected beacons from the other devices;
d) adjusting a frequency band for transmission by a respective device according to the determined time-frequency code; and
e) transmitting a plurality of symbols, as a symbol set, from the respective device using the adjusted frequency band.

2. The control method of claim 1, further comprising the step of:
f) repeating the adjusting and transmitting steps until a communication from the respective device is completed.

3. The control method of claim 2, wherein each repeated transmission of the plurality of symbols has a common a number of symbols transmitted.

4. The control method of claim 1, wherein the number of symbols transmitted consecutively using the adjusted frequency band is less than about 2000 symbols.

5. The control method of claim 1, further comprising the step of:
f) selecting the number of symbols transmitted using the adjusted frequency band when the selected number of symbols is sufficient to provide an average emission level on the adjusted frequency band in a predetermined time interval of less than a threshold level.

6. The control method of claim 1, wherein ones of repeated pluralities of symbols from respective devices are sets of symbols for communicating between or among the plurality of devices and each set of symbols includes successive symbols representing successive information bits of a respective communication and/or repeated symbols representing repeated information bits of the respective communication.

7. The control method of claim 6, further comprising the step of:
setting each frame interval and a corresponding intra-frame interval according to the established reservation, each frame interval and intra-frame interval being a plural, integral number of symbol set periods in duration.

8. The control method of claim 1, wherein step (c) of determining a time-frequency code includes determining a sequence of transmissions of the plurality of devices using each of the plurality of frequency bands, the method further comprising the steps of:
f) determining which one or ones of the transmitted plurality of symbols are corrupted for a respective device using the adjusted frequency band; and
g) adjusting a clock timing of the respective device according to which one or ones of the transmitted plurality of symbols are corrupted.

9. The control method of claim 8, wherein step (g) of adjusting the clock timing of the respective device includes the step of:
g-1) advancing the clock timing of the respective device, when a last symbol of the symbol set or an end of the symbol set is corrupted.

10. The control method of claim 8, wherein step (g) of adjusting the clock timing of the respective device includes the step of:
g-1) retarding the clock timing of the respective device, when a first symbol of the symbol set or a beginning portion of the symbol set is corrupted.

11. The control method of claim 9, wherein step (g-1) of advancing the clock timing includes the step of:
advancing the clock timing by an amount corresponding to a number of symbols at an end of the symbol set that is determined to be corrupted.

12. The control method of claim 10, wherein the step (g-1) of retarding the clock timing includes the step of:
retarding the clock timing by an amount corresponding to a number of symbols at a start of the symbol set that is determined to be corrupted.

13. The control method of claim 1, wherein step (c) of determining a time-frequency code includes determining a sequence of transmissions of the plurality of devices using each of the plurality of frequency bands, the method further includes the steps of:
f) determining whether a first symbol in the symbol set or a beginning portion of the symbol set is corrupted for a respective device using the adjusted frequency band; and
g) adjusting a clock timing of the respective device by a predetermined amount.

14. The control method of claim 13, wherein step (g) of adjusting the clock timing of the respective device includes the step of:
(g-1) retarding the clock timing of the respective device, when the first symbol of the symbol set or the beginning portion of the symbol set is corrupted.

15. The control method of claim 1, wherein step (c) of determining a time-frequency code includes determining a sequence of transmissions of the plurality of devices using each of the plurality of frequency bands, the method further includes the steps of:
f) determining whether a last symbol of the symbol set or an end portion of the symbol set is corrupted for a respective device using the adjusted frequency band; and
g) adjusting a clock timing of the respective device by a predetermined amount.

16. The control method of claim 15, wherein step (g) of adjusting the clock timing of the respective device includes the step of:
(g-1) advancing the clock timing of the respective device, when the last symbol of the symbol set or the end portion of the symbol set is corrupted.

17. The control method of claim 1, further comprising the step of:
offsetting a start of a frame for at least one device with respect to one or more other devices according to the detected beacons.

18. The control method of claim 1, further comprising the step of:
synchronizing a start of the respective frame intervals for each successive device responding with a corresponding beacon according to the established frame interval.

19. The control method of claim 18, further comprising the step of:
positioning the start of the respective frame interval for successive devices responding with the beacon based on a predefined symbol set duration.

20. The control method of claim 1, wherein step (e) of transmitting the plurality of symbols includes:
transmitting of the plurality of symbols according to an OFDM transmission method over a plurality of simultaneous channels.

21. A control method of band multiplexing communications from the plurality of devices in the communication system, the method comprising the steps of:
a) establishing a rotation, by each device, between or among a plurality of frequency bands for transmission;
b) transmitting a symbol set from each device at each of the established transmission frequency bands such that simultaneous transmissions by respective devices are in different transmission frequency bands;
c) determining whether a beginning portion or an ending portion of each respective symbol set for a respective device is corrupted; and
d) when the starting portion or the ending portion of the symbol set is determined to be corrupted in step (c), adjusting a clock timing of the respective device to reduce or substantial eliminate symbol corruption in subsequently transmitted symbol sets of the respective device.

22. The control method of claim 21, wherein:
step (c) of determining whether a beginning portion or an ending portion of each respective symbol set for a respective device is corrupted includes the step of determining, for the beginning portion of symbols, a number of corrupted symbol periods; and
step (d) of adjusting a clock timing of the respective device to reduce or substantial eliminate symbol corruption in subsequently transmitted symbol sets of the respective device includes, determining whether the number of corrupted symbol periods in the beginning portion is greater than a predetermined threshold and if the number of corrupted symbol periods in the beginning portion is greater than the predetermined threshold, retarding the clock timing of the respective device by a time corresponding to either a preset number symbol periods or a time corresponding to the determined number of corrupted symbol periods in the beginning portion of the respective symbol set.

23. The control method of claim 21, wherein:
step (c) of determining whether a beginning portion or an ending portion of each respective symbol set for a respective device is corrupted includes the step of determining, for the ending portion of symbols, a number of corrupted symbol periods; and
step (d) of adjusting a clock timing of the respective device to reduce or substantial eliminate symbol corruption in subsequently transmitted symbol sets of the respective device includes, determining whether the number of corrupted symbol periods in the ending portion is greater than a predetermined threshold and if the number of corrupted symbol periods in the ending portion is greater than the predetermined threshold, advancing the clock timing of the respective device by a time corresponding to either a preset number symbol periods or a time corresponding to the determined number of corrupted symbol periods in the ending portion of the respective symbol set.

24. A computer readable medium including software that is configured to control a general purpose computer to control communication from a device in the communication system by implementing a method according to claim 1.

25. The computer readable medium of claim 24, wherein the method further comprises the steps of:
f) determining which one or ones of the transmitted plurality of symbols for a respective device using the adjusted frequency band are corrupted; and
g) retarding a clock timing of the respective device, when a first symbol of the symbol set or a beginning portion of the symbol set is corrupted.
